(19) United States
(12) Patent Application Publication
(10) Pub. No.: US 2011/0163612 A1
(43) Pub. Date: Jul. 7, 2011

(54) LOAD DEVICES WITH LINEARIZATION TECHNIQUE EMPLOYED THEREIN

(76) Inventors: Jing-Hong Conan Zhan, HsinChu (TW); Jong-Woei Chen, Hsinchu City (TW)

(21) Appl. No.: 12/652,041

(22) Filed: Jan. 5, 2010

(51) Int. Cl. H02M 3/06

(52) U.S. Cl. 307/109

(57) ABSTRACT

A load device has tunable capacitive units including at least a first tunable capacitive unit and a second tunable capacitive unit with different inherent capacitive characteristics, respectively. Each of the first tunable capacitive unit and the second tunable capacitive unit has a first node and a second node, where the first nodes of the first tunable capacitive unit and the second tunable capacitive unit are coupled to a first voltage, the second node of the first tunable capacitive unit is coupled to a second voltage, and the second node of the second tunable capacitive unit is coupled to a third voltage.

### BACKGROUND

The disclosed embodiments of the present invention relate to load devices with linearization technique employed therein, and more particularly, to a load device having tunable capacitive units with different semiconductor structures/threshold voltages and a load device having tunable capacitive units which have the same inherent capacitive characteristic and are directly connected to a supply voltage and a ground voltage, respectively.

Varactor devices are commonly used in a variety of applications which require tunable capacitance. Therefore, linearity of the C-V curve of the varactor device would affect the overall performance of the application. There are several conventional approaches designed to linearize the varactor device's C-V curve. For example, one conventional approach is a resistor DAC (R-DAC) based solution which employs an R-DAC to shift the bias voltages of varactors of the same type to thereby make an equivalent (composite) C-V curve of a combination of the varactors become more linear. However, the R-DAC would consume current, generate undesired noise, degrade the quality factor (Q factor), and require AC grounding capacitors which consume the chip area.

Another conventional approach is an opposite C-V curve based solution which connects varactors with the same type but opposite C-V curves so that an equivalent C-V curve of a combination of the varactors becomes more linear. However, the opposite C-V curve based solution requires a differential control voltage pair which may not be available in certain applications. Additionally, such a connection of varactors would introduce significant parasitic capacitance unavoidably.

Therefore, an innovative and efficient means to linearize a C-V curve of a varactor device is highly demanded.

### SUMMARY

In accordance with exemplary embodiments of the present invention, a load device having tunable capacitive units with different semiconductor structures/threshold voltages and a load device having tunable capacitive units which have the same inherent capacitive characteristic and are directly connected to a supply voltage and a ground voltage, respectively, are disclosed.

According to a first aspect of the present invention, an exemplary load device has a plurality of tunable capacitive units, including at least a first tunable capacitive unit and a second tunable capacitive unit with different inherent capacitive characteristics, respectively. Each of the first tunable capacitive unit and the second tunable capacitive unit has a first node and a second node. The first nodes of the first tunable capacitive unit and the second tunable capacitive unit are coupled to a first voltage. The second node of the first tunable capacitive unit is coupled to a second voltage, and the second node of the second tunable capacitive unit is coupled to a third voltage.

According to a second aspect of the present invention, an exemplary load device has a plurality of tunable capacitive units, including at least a first tunable capacitive unit and a second tunable capacitive unit with substantially the same inherent capacitive characteristic. Each of the first tunable capacitive unit and the second tunable capacitive unit has a first node and a second node. The first nodes of the first tunable capacitive unit and the second tunable capacitive unit are coupled to a control voltage configured for tuning capacitive values of the first tunable capacitive unit and the second tunable capacitive unit. The second node of the first tunable capacitive unit is directly connected to a supply voltage, and the second node of the second tunable capacitive unit is directly connected to a ground voltage.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a block diagram illustrating a first exemplary embodiment of a load device according to the present invention.

FIG. 2 is a diagram showing exemplary P-channel MOSFET implementations of a tunable capacitive unit.

FIG. 3 is a diagram showing exemplary N-channel MOSFET implementations of a tunable capacitive unit.

FIG. 4 shows individual C-V curves CV1, CV2, CV3 of an N-MOSFET with regular threshold voltage, an accumulation mode N-MOSFET, and an N-MOSFET with regular threshold voltage, respectively.

FIG. 5 shows individual characteristic curves K_{VCO}−1, K_{VCO}−2, K_{VCO}−3 of VCO gains of an N-MOSFET with regular threshold voltage, an accumulation mode N-MOSFET, and an N-MOSFET with regular threshold voltage, respectively.

FIG. 6 shows an equivalent C-V curve CV′ of a combination of an N-MOSFET with regular threshold voltage, an accumulation mode N-MOSFET, and an N-MOSFET with regular threshold voltage.

FIG. 7 shows an equivalent characteristic curve K_{VCO}′ of the VCO gain of a combination of an N-MOSFET with regular threshold voltage, an accumulation mode N-MOSFET, and an N-MOSFET with regular threshold voltage.

FIG. 8 is a block diagram illustrating a second exemplary embodiment of a load device according to the present invention.

FIG. 9 is a block diagram of a first exemplary tank circuit having one of the afore-mentioned load device configurations implemented therein.

FIG. 10 is a block diagram of a second exemplary tank circuit having one of the afore-mentioned load device configurations implemented therein.

FIG. 11 is a block diagram of a third exemplary tank circuit having one of the afore-mentioned load device configurations implemented therein.

### DETAILED DESCRIPTION

Certain terms are used throughout the description and following claims to refer to particular components. As one skilled in the art will appreciate, manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

To avoid ambiguity of the terminology used throughout the detailed description and following claims, the term “inherent capacitive characteristic” is defined here. The intended meaning of the term “inherent capacitive characteristic” is to encompass any capacitive characteristic owned by an electronic component at the time the electronic component was made. For example, an inherent capacitive characteristic of an electronic component was determined or known at the time the electronic component was made. Therefore, prior to the electronic component is in operation and affected by any external operating condition and/or any controlling/adjusting/calibrating means, a capacitive characteristic owned by the electronic component may be termed as the inherent capacitive characteristic. One exemplary inherent capacitive characteristic is a capacitance versus voltage curve (C-V curve) inherently owned by the electronic component (e.g., a semiconductor device). However, this is for illustrative purposes only, and is not meant to be taken as a limitation.

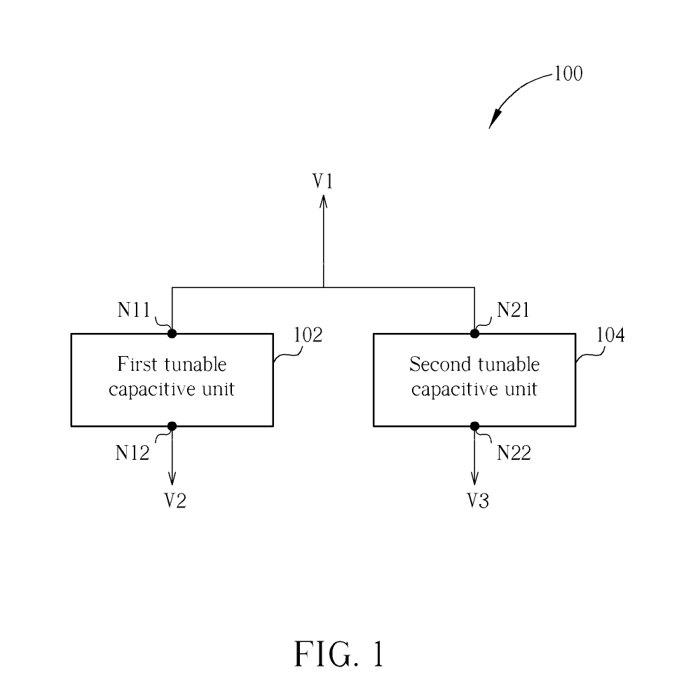

FIG. 1 is a block diagram illustrating a first exemplary embodiment of a load device according to the present invention. The exemplary load device 100 has a plurality of tunable capacitive units, including at least a first tunable capacitive unit 102 and a second tunable capacitive unit 104 with different inherent capacitive characteristics (e.g., different C-V curves), respectively. It should be noted that the number of tunable capacitive units implemented in the load device 100 is adjustable, depending upon design requirements. That is, only two tunable capacitive units are shown in FIG. 1 for illustrative purposes, and this by no means implies that the number of tunable capacitive units implemented in the load device 100 is limited to two. Each of the first tunable capacitive unit 102 and the second tunable capacitive unit 104 has a first node N11, N21 and a second node N12, N22. As shown in FIG. 1, first nodes N11, N21 of the first tunable capacitive unit 102 and the second tunable capacitive unit 104 are coupled to a first voltage V1, the second node N12 of the first tunable capacitive unit 102 is coupled to a second voltage V2, and the second node N22 of the second tunable capacitive unit 104 is coupled to a third voltage V3.

The exemplary load device 100 can have a linearized C-V curve by properly configuring the first tunable capacitive unit 102 and the second tunable capacitive unit 104. In one implementation of the exemplary load device 100, the first tunable capacitive unit 102 and the second tunable capacitive unit 104 are semiconductor devices with different threshold voltages and/or different semiconductor structures, thereby satisfying the requirements of making the first tunable capacitive unit 102 and the second tunable capacitive unit 104 have different inherent capacitive characteristics. Therefore, with proper wiring and sizing of the semiconductor devices, a linearized C-V curve can be obtained.

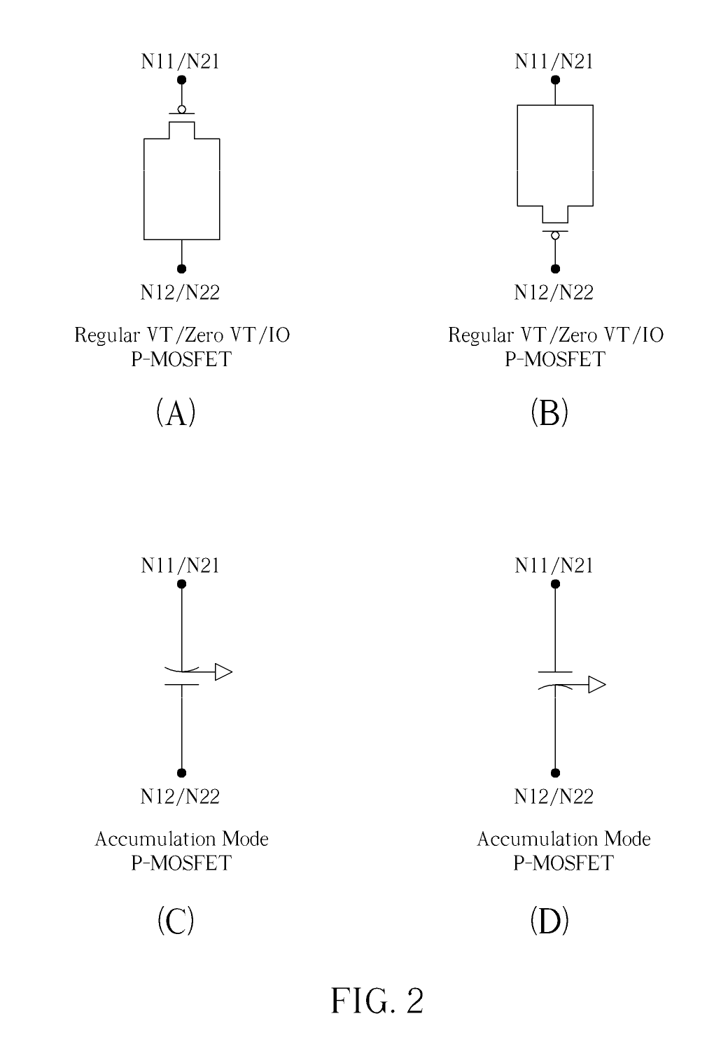

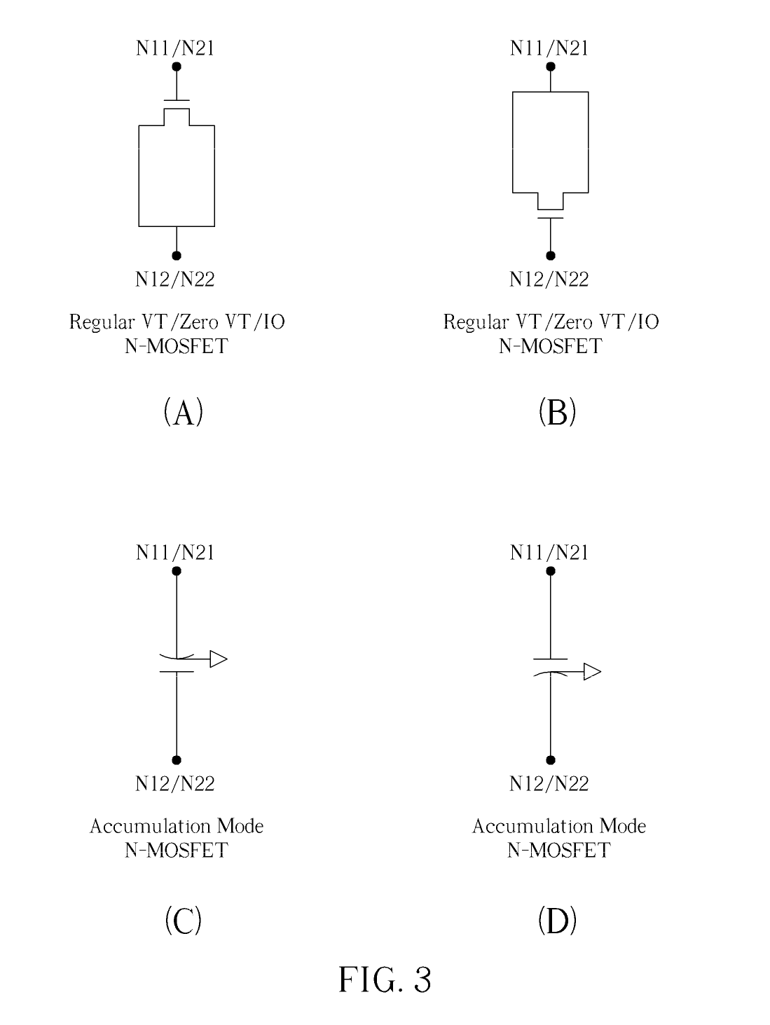

Please refer to FIG. 2 and FIG. 3. FIG. 2 is a diagram showing exemplary P-channel MOSFET implementations of a tunable capacitive unit (e.g., the aforementioned first/second tunable capacitive unit), and FIG. 3 is a diagram showing exemplary N-channel MOSFET implementations of a tunable capacitive unit (e.g., the aforementioned first/second tunable capacitive unit). Therefore, as long as the threshold voltages of the first tunable capacitive unit 102 and the second tunable capacitive unit 104 are different, the first tunable capacitive unit 102 may be a P-channel MOSFET/N-channel MOSFET with regular threshold voltage, zero threshold voltage, high threshold voltage (e.g., the MOSFET is an 10 device), or low threshold voltage (e.g., the MOSFET is an accumulation mode MOSFET), and the second tunable capacitive unit 104 may be a P-channel MOSFET/N-channel MOSFET with regular threshold voltage, zero threshold voltage, high threshold voltage, or low threshold voltage. More specifically, a threshold voltage of the first tunable capacitive unit 102 is one of the regular threshold voltage, the zero threshold voltage, the high threshold voltage, and the low threshold voltage, whereas a threshold voltage of the second tunable capacitive unit is another of the regular threshold voltage, the zero threshold voltage, the high threshold voltage, and the low threshold voltage. It should be noted that in an exemplary design which employs above-mentioned MOSFETs to realize the first tunable capacitive unit 102 and the second tunable capacitive unit 104, the load device 100 has no diode-based varactor unit and R-DAC implemented therein. The implementation of diode-based varactor units requires extra mask cost, and the diode-based varactor unit usually has poorer Q factor than the MOSFET-based varactor unit in a high-frequency application, such as an application operated under the mmW frequency range. In addition, as mentioned above, the implementation of the R-DAC has additional current consumption and lowered Q factor, requires decoupling capacitor area, and generates undesired noise. Therefore, as the load device 100 has no diode-based varactor unit and R-DAC implemented therein, the production cost and size of the load device 100 can be reduced, and the performance of the load device 100 can be improved.

In another implementation of the exemplary load device 100, the first tunable capacitive unit 102 and the second tunable capacitive unit 104 are semiconductor devices with different semiconductor structures, thereby satisfying the requirements of making the first tunable capacitive unit 102 and the second tunable capacitive unit 104 have different inherent capacitive characteristics. Therefore, as long as the semiconductor structures of the first tunable capacitive unit 102 and the second tunable capacitive unit 104 are different, the first tunable capacitive unit 102 may be a bipolar junction transistor (BJT), a heterojunction bipolar transistor (HBT), a high electron mobility transistor (HEMT), a field-effect transistor (FET), a varactor, or a diode, and the second tunable capacitive unit 104 may be a BF, an HBT, an HEMT, an FET, a varactor, or a diode. More specifically, the first tunable capacitive unit 102 is one of the BJT, the HBT, the HEMT, the FET, the varactor, and the diode, whereas the second tunable capacitive unit 104 is another of the BJT, the HBT, the HEMT, the FET, the varactor, and the diode. It should be noted that in an exemplary design which employs above-mentioned semiconductor devices to realize the first tunable capacitive unit 102 and the second tunable capacitive unit 104, the load device 100 has no R-DAC implemented therein. Therefore, the production cost and size of the load device 100 can be reduced, and the performance of the load device 100 can be improved.

In yet another implementation of the exemplary load device 100, the first tunable capacitive unit 102 and the second tunable capacitive unit 104 are semiconductor devices with different semiconductor structures and different thresholds. The same objective of making a load device have a linearized C-V curve is achieved. That is, any means capable of making the first tunable capacitive unit 102 and the second tunable capacitive unit 104 have different inherent capacitive characteristics all obey the spirit of the present invention.

In aforementioned implementations of the load device 100, the first voltage V1 may be a control voltage configured for tuning capacitive values of the first tunable capacitive unit 102 and the second tunable capacitive unit 104, and each of the second voltage V2 and the third voltage V3 is a specific reference voltage. In one design, the voltage level of the second voltage V2 is set identical to that of the third voltage V3. In an alternative design, the voltage level of the second voltage V2 is set different from that of the third voltage V3. Furthermore, the specific reference voltage mentioned above may be a supply voltage or a ground voltage of an application which has the load device 100 employed therein. However, this is for illustrative purposes only, and is not meant to be taken as a limitation of the present invention.

By way of example, the first node N11/N21 of each transistor shown in FIG. 2 and FIG. 3 is configured for receiving an adjustable control voltage, and the second node N12/N22 of each transistor shown in FIG. 2 and FIG. 3 is configured for receiving a fixed reference voltage. For example, one of the second voltage V2 and the third voltage V3 is set as VDD/2, and the other of the second voltage V2 and the third voltage V3 is set as GND.

Alternatively, in aforementioned implementations of the load device 100, the first voltage V1 is a reference voltage, and the second voltage V2 and the third voltage V3 are control voltages configured for tuning capacitive values of the first tunable capacitive unit 102 and the second tunable capacitive unit 104, respectively. Similarly, the voltage level of the second voltage V2 may be identical to or different from that of the third voltage V3, depending upon design requirements. BY way of example, the specific reference voltage mentioned above may be a supply voltage or a ground voltage of an application which has the load device 100 employed therein. However, this is for illustrative purposes only, and is not meant to be taken as a limitation of the present invention. In addition, the first node N11/N21 of each transistor shown in FIG. 2 and FIG. 3 is configured for receiving a fixed reference voltage, and the second node N12/N22 of each transistor shown in FIG. 2 and FIG. 3 is configured for receiving an adjustable control voltage.

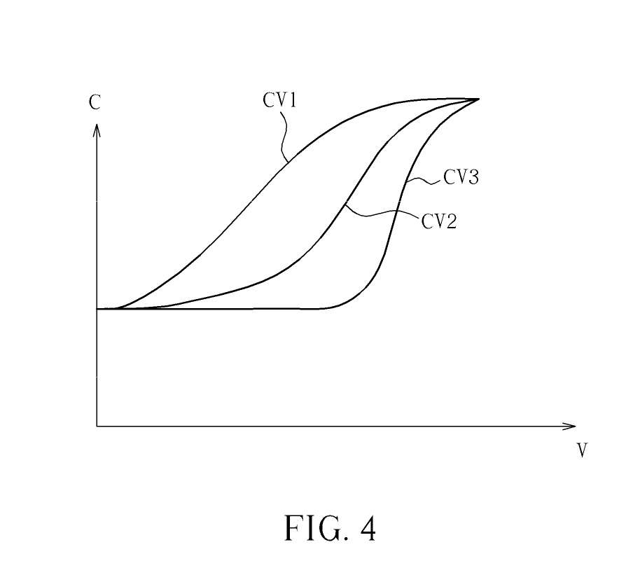

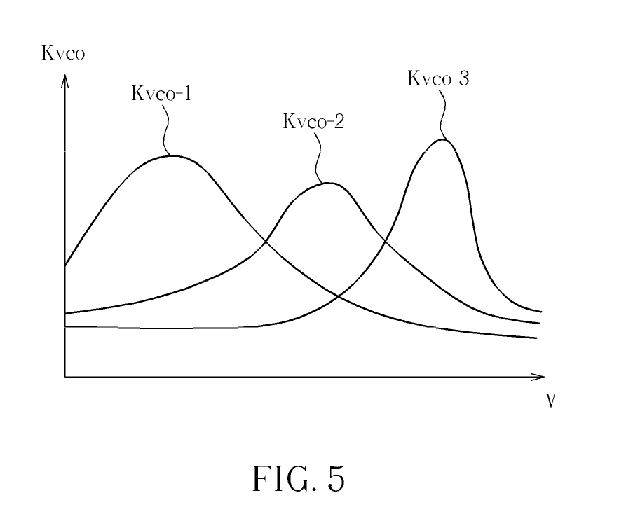

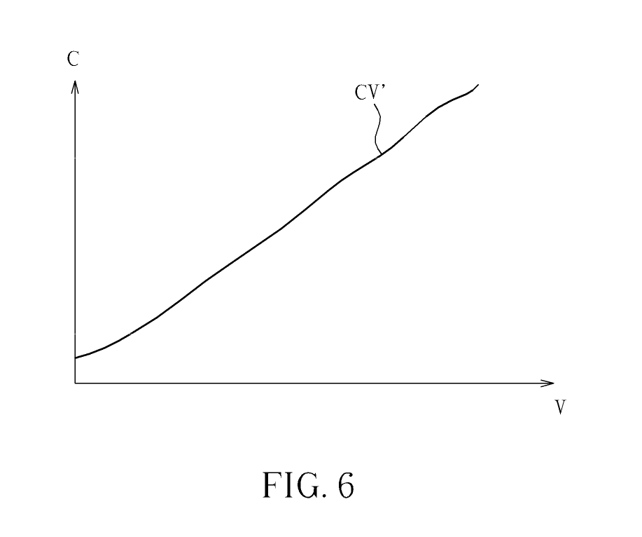

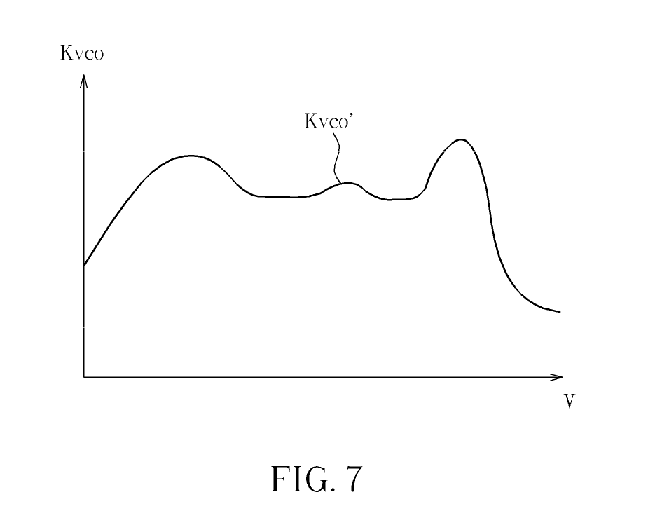

Due to the combination of the first tunable capacitive unit 102 and the second tunable capacitive unit 104 with different inherent capacitive characteristics, the equivalent (composite) C-V curve of the load device 100 is more linear. It should be noted that the load device 100 shown in FIG. 1 can be employed in any application which requires tunable capacitance. By way of example, but not limitation, the load device 100 can be employed in a voltage-controlled oscillator (VCO) or a phase shifter. As the load device 100 has a linearized C-V curve, the characteristic curve of the gain K_{VCO} of the VCO or the phase tuning curve of the phase shifter would be more linear. Consider a case where VCO's LC tank has a load device implemented using an N-MOSFET with regular threshold voltage, an accumulation mode N-MOSFET, and an N-MOSFET with regular threshold voltage according to an embodiment of the present invention. Simulation results are shown in FIG. 4-FIG. 7, where FIG. 4 shows individual C-V curves CV1, CV2, CV3 of the N-MOSFET with regular threshold voltage, the accumulation mode N-MOSFET, and the N-MOSFET with regular threshold voltage, respectively, FIG. 5 shows individual characteristic curves K_{VCO}−1, K_{VCO}−2, K_{VCO}−3 of the VCO gains of the N-MOSFET with regular threshold voltage, the accumulation mode N-MOSFET, and the N-MOSFET with regular threshold voltage, respectively, FIG. 6 shows an equivalent C-V curve CV′ of the combination of the N-MOSFET with regular threshold voltage, the accumulation mode N-MOSFET, and the N-MOSFET with regular threshold voltage, and FIG. 7 shows an equivalent characteristic curve K_{VCO}′ of the VCO gain of the combination of the N-MOSFET with regular threshold voltage, the accumulation mode N-MOSFET, and the N-MOSFET with regular threshold voltage. As one can see from FIG. 6 and FIG. 7, the C-V curve is linearized, and the characteristic curve of the VCO gain is smoother within a specific control voltage range.

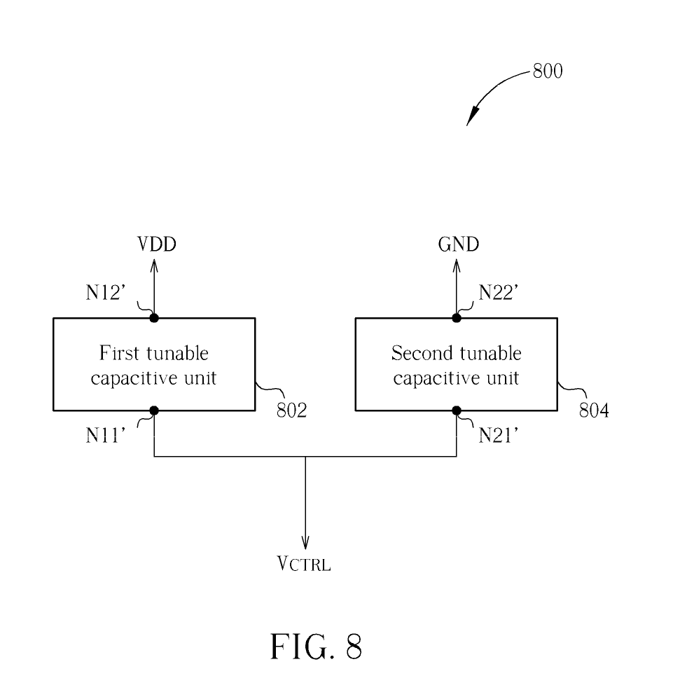

FIG. 8 is a block diagram illustrating a second exemplary embodiment of a load device according to the present invention. The exemplary load device 800 has a plurality of tunable capacitive units, including at least a first tunable capacitive unit 802 and a second tunable capacitive unit 804 with substantially the same inherent capacitive characteristic. Each of the first tunable capacitive unit 802 and the second tunable capacitive unit 804 has a first node N11′, N21′ and a second node N12′, N22′. First nodes N11′, N21′ of the first tunable capacitive unit 802 and the second tunable capacitive unit 804 are coupled to a control voltage V_{CTRL} configured for tuning capacitive values of the first tunable capacitive unit 802 and the second tunable capacitive unit 804. The second node N12′ of the first tunable capacitive unit 802 is directly connected to a supply voltage VDD, and the second node N22′ of the second tunable capacitive unit 804 is directly connected to a ground voltage GND. The same objective of making a load device have a linearized C-V curve is achieved by such a configuration shown in FIG. 8. Similarly, as can be seen from FIG. 8, the load device 800 has no R-DAC implemented therein. Therefore, the production cost and size of the load device 800 can be reduced, and the performance of the load device 800 can be improved.

It should be noted that the naming of the “load device” does not imply that the load device only serves as a load of a circuit; any circuit component having the afore-mentioned load device configuration still falls within the scope of the present invention.

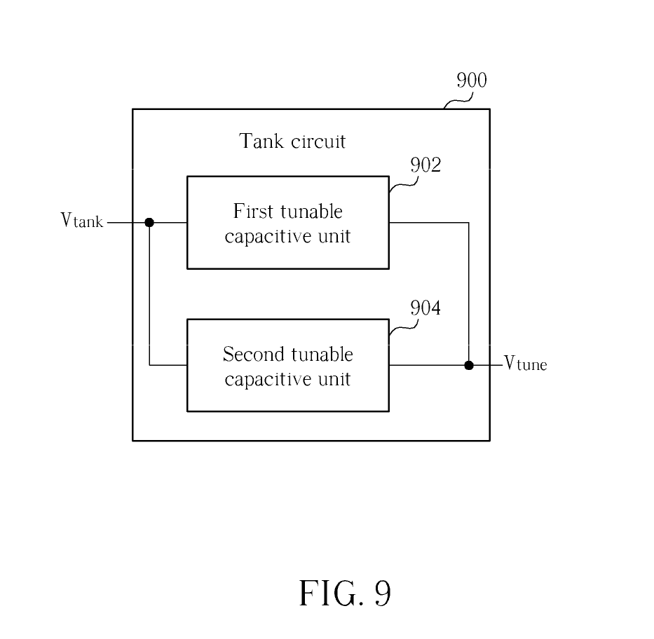

Please refer to FIG. 9-FIG. 11, which show different tank circuits 900, 1000, 1100 each having one of the afore-mentioned load device configurations implemented therein. Regarding the exemplary tank circuit 900 in FIG. 9, the same tank voltage Vₜₐₙₖ, serving as the specific reference voltage mentioned above, is supplied to both of the first tunable capacitive unit 902 and the second tunable capacitive unit 904 included in the tank circuit 900, where the tank circuit 900 may be employed in a voltage-controlled oscillator or a phase shifter. In addition, the same tuning voltage Vₜᵤₙₑ, serving as the control voltage mentioned above, is supplied to both of the first tunable capacitive unit 902 and the second tunable capacitive unit 904.

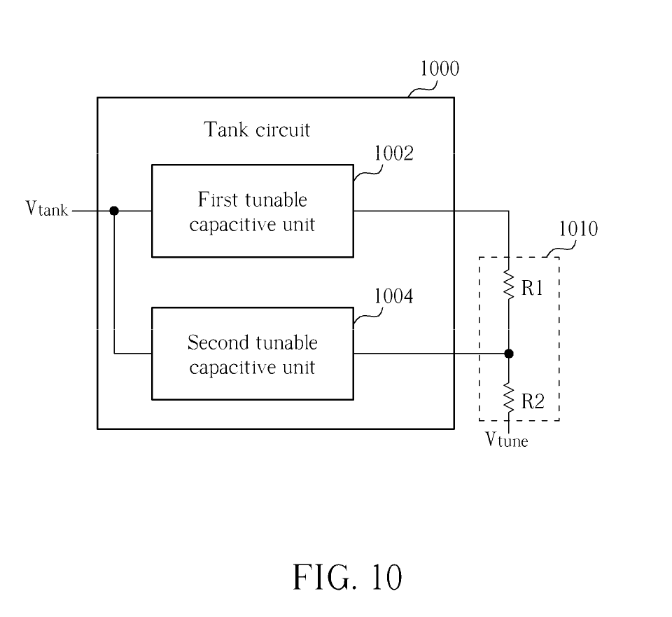

Regarding the exemplary tank circuit 1000 in FIG. 10, the same tank voltage Vₜₐₙₖ, serving as the specific reference voltage mentioned above, is supplied to both of the first tunable capacitive unit 1002 and the second tunable capacitive unit 1004 included in the tank circuit 1000, where the tank circuit 1000 may be employed in a voltage-controlled oscillator or a phase shifter. The major difference between the tank circuit 1000 and tank circuit 900 is that the first tunable capacitive unit 1002 and the second tunable capacitive unit 1004 are coupled to a voltage divider 1010 composed of two resistors R1 and R2, and the tuning voltage Vₜᵤₙₑ is voltage-divided by the voltage divider 1010 to generate different control voltages supplied to the first tunable capacitive unit 1002 and the second tunable capacitive unit 1004, respectively.

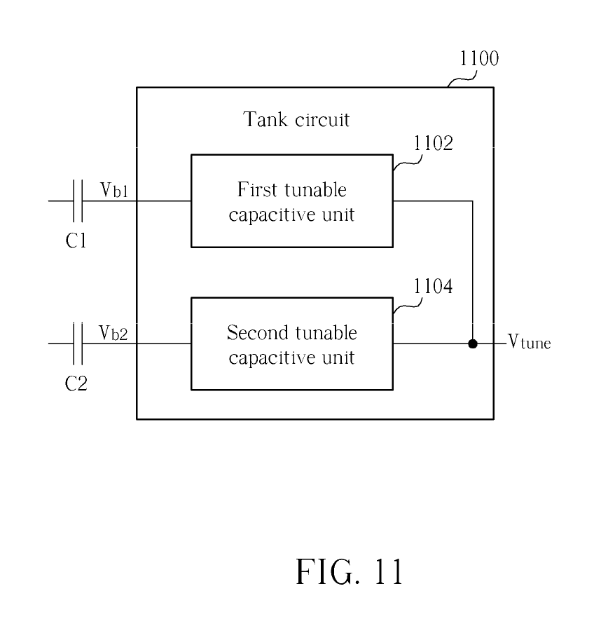

Regarding the exemplary tank circuit 1100 in FIG. 11, the same tuning voltage Vₜᵤₙₑ, serving as the control voltage mentioned above, is supplied to both of the first tunable capacitive unit 1102 and the second tunable capacitive unit 1104 included in the tank circuit 1100, where the tank circuit 1100 may be employed in a voltage-controlled oscillator or a phase shifter. The major difference between the tank circuit 1100 and tank circuit 900 is that the first tunable capacitive unit 1002 and the second tunable capacitive unit 1004 are coupled to coupling capacitors C1 and C2, respectively. Thus, different bias voltages V_{b1} and V_{b2}, serving as specific reference voltages mentioned above, are supplied to the first tunable capacitive unit 1102 and the second tunable capacitive unit 1104, respectively.

As a person skilled in the art can readily understand details of the tank circuits 900, 1000, 1100 each having one of the afore-mentioned load device configurations implemented therein after reading above paragraphs directed to the exemplary load device configurations of the present invention, further description is omitted here for brevity.

Those skilled in the art will readily observe that numerous modifications and alterations of the device and method may be made while retaining the teachings of the invention.

What is claimed is:

1. A load device, comprising:
a plurality of tunable capacitive units, including at least a first tunable capacitive unit and a second tunable capacitive unit with different inherent capacitive characteristics, respectively, wherein each of the first tunable capacitive unit and the second tunable capacitive unit has a first node and a second node, the first nodes of the first tunable capacitive unit and the second tunable capacitive unit are coupled to a first voltage, the second node of the first tunable capacitive unit is coupled to a second voltage, and the second node of the second tunable capacitive unit is coupled to a third voltage.

2. The load device of claim 1, wherein the first voltage is a control voltage configured for tuning capacitive values of the first tunable capacitive unit and the second tunable capacitive unit; and each of the second voltage and the third voltage is a specific reference voltage.

3. The load device of claim 2, wherein the specific reference voltage is a supply voltage or a ground voltage.

4. The load device of claim 1, wherein a voltage level of the second voltage is identical to a voltage level of the third voltage.

5. The load device of claim 1, wherein a voltage level of the second voltage is different from a voltage level of the third voltage.

6. The load device of claim 1, wherein the first voltage is a specific reference voltage, and the second voltage and the third voltage are control voltages configured for tuning capacitive values of the first tunable capacitive unit and the second tunable capacitive unit, respectively.

7. The load device of claim 6, wherein the specific reference voltage is a supply voltage or a ground voltage.

8. The load device of claim 1, wherein the first tunable capacitive unit and the second tunable capacitive unit are semiconductor devices with different semiconductor structures.

9. The load device of claim 8, wherein the first tunable capacitive unit is one of a bipolar junction transistor (BJT), a heterojunction bipolar transistor (HBT), a high electron mobility transistor (HEMT), a field-effect transistor (FET), a varactor, and a diode, and the second tunable capacitive unit is another of the BJT, the HBT, the HEMT, the FET, the varactor, and the diode.

10. The load device of claim 1, wherein the first tunable capacitive unit and the second tunable capacitive unit are semiconductor devices with different threshold voltages.

11. The load device of claim 10, wherein a threshold voltage of the first tunable capacitive unit is one of a regular threshold voltage, a zero threshold voltage, a high threshold voltage, and a low threshold voltage, and a threshold voltage of the second tunable capacitive unit is another of the regular threshold voltage, the zero threshold voltage, the high threshold voltage, and the low threshold voltage.

12. The load device of claim 1, being employed in a voltage-controlled oscillator (VCO).

13. The load device of claim 1, being employed in a phase shifter.

14. A load device, comprising:
a plurality of tunable capacitive units, including at least a first tunable capacitive unit and a second tunable capacitive unit with substantially the same inherent capacitive characteristic, wherein each of the first tunable capacitive unit and the second tunable capacitive unit has a first node and a second node, the first nodes of the first tunable capacitive unit and the second tunable capacitive unit are coupled to a control voltage configured for tuning capacitive values of the first tunable capacitive unit and the second tunable capacitive unit, the second node of the first tunable capacitive unit is directly connected to a supply voltage, and the second node of the second tunable capacitive unit is directly connected to a ground voltage.

15. The load device of claim 14, being employed in a voltage-controlled oscillator (VCO).

16. The load device of claim 14, being employed in a phase shifter.
